(19) United States
(12) Patent Application Publication
(10) Pub. No.: US 2015/0059080 A1
(43) Pub. Date: Mar. 5, 2015

(54) DUAL LAYERED POOL LINER

(71) Applicants: Allan J. MacKinlay, Maple Glen, PA (US); John E. Pomeroy, White Haven, PA (US); Scot Martinelli, Mountain Top, PA (US); Christopher L. Hackett, Shavertown, PA (US)

(72) Inventors: Allan J. MacKinlay, Maple Glen, PA (US); John E. Pomeroy, White Haven, PA (US); Scot Martinelli, Mountain Top, PA (US); Christopher L. Hackett, Shavertown, PA (US)

(73) Assignee: CRESTWOOD MEMBRANES, INC., Mountain Top, PA (US)

(21) Appl. No.: 14/017,872

(22) Filed: Sep. 4, 2013

(51) Int. Cl. E04H 4/14; B32B 37/12; B32B 37/14; B32B 27/08; B32B 38/06; B32B 7/12; B32B 27/30; B32B 37/06; B32B 37/16

(52) U.S. Cl. CPC E04H 4/14; B32B 37/06; B32B 37/1284; B32B 37/144; B32B 37/16; B32B 38/06; B32B 7/12; B32B 27/304; B32B 27/08; B32B 2307/412; B32B 2307/4023; B32B 2307/54; B32B 2327/06; E04H 2004/146; B32B 2250/02
USPC 4/506; 156/60; 156/220

(57) ABSTRACT

A pool liner having a first polymeric liner sheet having first and second sides and a substantially light transparent second polymeric liner sheet having first side and second sides. A colored indicia is positioned on at least a portion of the first side of the first polymeric liner sheet and/or on at least a portion of the first side of the substantially transparent second polymeric liner sheet. The first side of the second polymeric liner sheet is attached to the first side of the first polymeric liner sheet such that the colored indicia is positioned between the first side of the first polymeric liner sheet and the first side of the second polymeric liner sheet. Each sheet has a minimum longitudinal direction and transverse direction elongation at break of about 160% and about 160% respectively; a maximum tensile strength in each of the longitudinal direction and transverse directions of about 3000 psi; a maximum secant modulus in each of the longitudinal direction and transverse directions of about 2100 psi.

### BACKGROUND OF THE INVENTION

1. Field of the Invention

The present invention relates to pool liners, such as liners for in-ground swimming pools, and more particularly, to flexible plastic liners for swimming pools that are attached to the upper edge of a swimming pool wall. Such flexible plastic liners provide a water-tight compartment to hold water in the pool.

2. Description of the Related Art

There is great commercial interest in producing in-ground swimming pools. The majority of in-ground swimming pools are of the vinyl-lined or vinyl-sided variety. These pools comprise a concave structural shell placed in a hole excavated in the ground. The structural shell provides the framework of pools walls on which a vinyl liner is placed. The pool walls over which the liner is placed can be made from a thin sheeting of wood, aluminum, thin steel, plastic, concrete or any other suitable material behind which is the surrounding earth. In between the liner and wall, there may optionally be a layer of polyethylene open-cell foam sheeting. The floor of the pool is a planar surface, and usually comprises a layer such as sand, vermiculite or concrete. These constructions rely on the pressure of the water in the pool against the walls surrounding it to maintain the wall structural integrity of the walls, as well as to maintain the original pool liner in place. The pool is then filled with water from a water source such as a tank. The water pressure pushes the liner against the structural shell and holds it in place. A vacuum pump may optionally assist is removing air between the liner and the structural shell during liner installation. Known liners are constructed from a single sheet of waterproof material which is often made from vinyl. Liners are often decorated with a colorful design. However, vinyl liners have several major drawbacks including scuffing of the liner, particularly the upper portion of the liner both above the water line of a filled pool as well as on the floor from automatic cleaners, and the colorful design becomes faded due to weathering and exposure to sun light and pool chemicals. Typically, such unsightly scuffed or faded pool liners are unnecessarily replaced, even though they may still be structurally sound. This invention provides a dual layered pool liner which resists surface scuffing and fading and unwanted removal of liner designs. One solution proposed by U.S. Pat. No. 6,662,383 is to provide a pool liner that comprises a main liner subassembly and a secondary liner subassembly. The secondary liner subassembly comprises a secondary liner sheet loosely overlapping an upper portion of the main liner sheet and having a bottom edge that is attached to the main liner sheet. After the portion of the assembly facing the sun has faded, it can be removed to reveal an fresh underlying portion of the assembly. U.S. Pat. No. 5,191,007 provides polyvinyl chloride compositions in the form of flexible sheets and swimming pool liners of such compositions which contain significant quantities of an ultra high molecular weight polyvinyl chloride resin together with a heat stabilizer, plasticizer and optional additives. U.S. Pat. No. 7,578,596 shows a liner configured to transmit light through a light-transmitting portion of the liner to illuminate the swimming pool. The liner of this invention has a first polymeric liner sheet having a first side and a second side; a colored indicia on the first side of the first polymeric liner sheet, and a substantially light transparent second polymeric liner sheet having a first side and a second side; the first side of the second polymeric liner sheet is attached to the first side of the first polymeric liner sheet such that the colored indicia is positioned between the first side of the first polymeric liner sheet and the first side of the second polymeric liner sheet. The two sheets thus protect the colored design. Such a construction increases fade resistance of the colored ink which forms the design, and provides an overall higher level of scratch, scuffing, stain and abrasion resistance to the liner. There is also a lower tendency of chlorine, mold and fungus to permeate the liner, and a decreased tendency for extraction of polymer additives from the underlying first polymeric liner sheet.

### SUMMARY OF THE INVENTION

The invention provides a pool liner comprising a first polymeric liner sheet having a first side and a second side; a substantially light transparent second polymeric liner sheet having a first side and a second side; a colored indicia on at least a portion of the first side of the first polymeric liner sheet and/or a colored indicia on at least a portion of the first side of the substantially transparent second polymeric liner sheet; the first side of the second polymeric liner sheet being attached to the first side of the first polymeric liner sheet such that the colored indicia is positioned between the first side of the first polymeric liner sheet and the first side of the second polymeric liner sheet, each of the first polymeric liner sheet and the second polymeric liner sheet defining a longitudinal direction, and a transverse direction orthogonal to the longitudinal direction, each of the first polymeric liner sheet and the second polymeric liner sheet having a minimum longitudinal direction elongation at break of about 160%, a minimum transverse direction elongation at break of about 160%, a maximum tensile strength in the longitudinal direction of about 3000 pounds per square inch, a maximum tensile strength in the transverse direction of about 3000 pounds per square inch, a maximum secant modulus in the longitudinal direction of about 2100 pounds per square inch, and a maximum secant modulus in the transverse direction of about 2100 pounds per square inch.

The invention also provides a pool assembly comprising a substantially concave pool defining inside walls, and the above described pool liner positioned on substantially the entirety of the inside walls.

The invention also provides a process for producing a pool liner which comprises:

a) providing a first polymeric liner sheet having a first side and a second side;
b) providing a substantially light transparent second polymeric liner sheet having a first side and a second side;
a colored indicia on at least a portion of the first side of the first polymeric liner sheet and/or a colored indicia on at least a portion of the first side of the substantially transparent second polymeric liner sheet; wherein each of the first polymeric liner sheet and the second polymeric liner sheet define a longitudinal direction, and a transverse direction orthogonal to the longitudinal direction, each of the first polymeric liner sheet and the second polymeric liner sheet having a minimum longitudinal direction elongation at break of about 160%, a minimum transverse direction elongation at break of about 160%, a maximum tensile strength in the longitudinal direction of about 3000 pounds per square inch, a maximum tensile strength in the transverse direction of about 3000 pounds per square inch, a maximum secant modulus in the longitudinal direction of about 2100 pounds per square inch, and a maximum secant modulus in the transverse direction of about 2100 pounds per square inch;
c) attaching the first side of the second polymeric liner sheet to the first side of the first polymeric liner sheet such that the colored indicia is positioned between the first side of the first polymeric liner sheet and the first side of the second polymeric liner sheet.

### BRIEF DESCRIPTION OF THE DRAWINGS

FIG. 1(a) is an exploded view of the component parts of a pool liner according to the invention with a colored indicia positioned on the first side of the first polymeric liner sheet.

FIG. 1(b) is an exploded view of the component parts of a pool liner according to the invention with a colored indicia positioned on the first side of the second polymeric liner sheet.

FIG. 2 shows an embodiment of the invention wherein the transparent second polymeric liner sheet is provided with surface embossing.

FIG. 3 shows an embodiment of the invention wherein the first and second polymeric liner sheets prior to being attached via an intermediate adhesive.

FIG. 4 shows a pool liner with first and second polymeric liner sheets attached via an adhesive embedding colored indicia.

### DESCRIPTION OF THE INVENTION

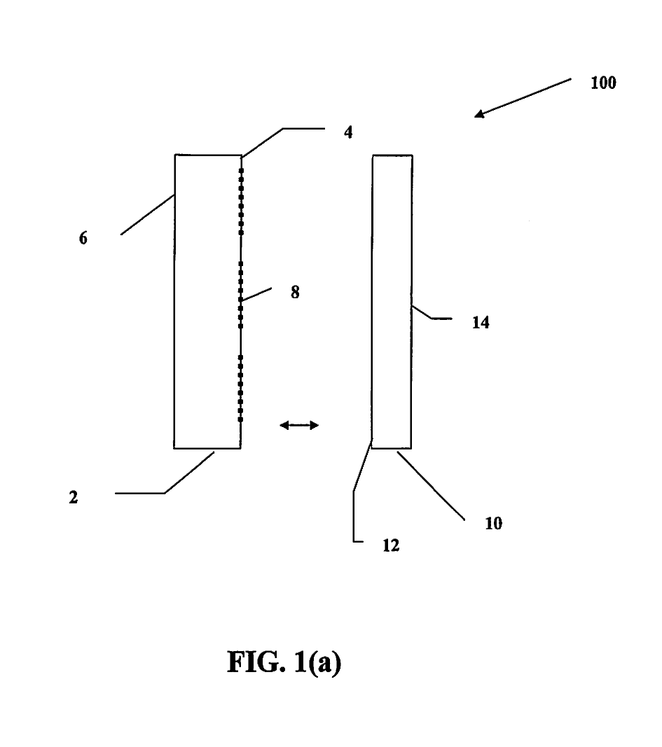

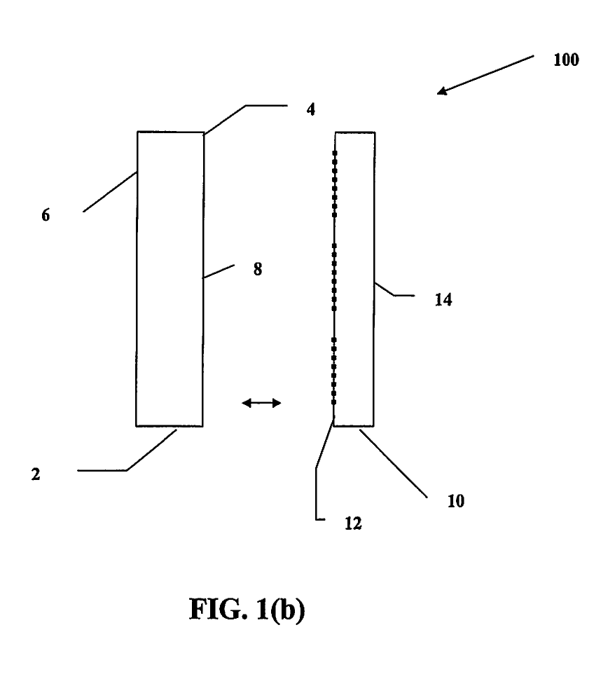

FIG. 1(a) and FIG. 1(b) show the component parts of a pool liner 100 according to the invention. It comprises a first polymeric liner sheet 2 having a first side 4 and a second side 6. The liner then comprises a substantially light transparent second polymeric liner sheet 10 having a first side 12 and a second side 14. A colored indicia 8 is positioned on one or both of at least a portion of the first side 4 of the first polymeric liner sheet 2 and/or the first side 12 of the second polymeric liner sheet 10.

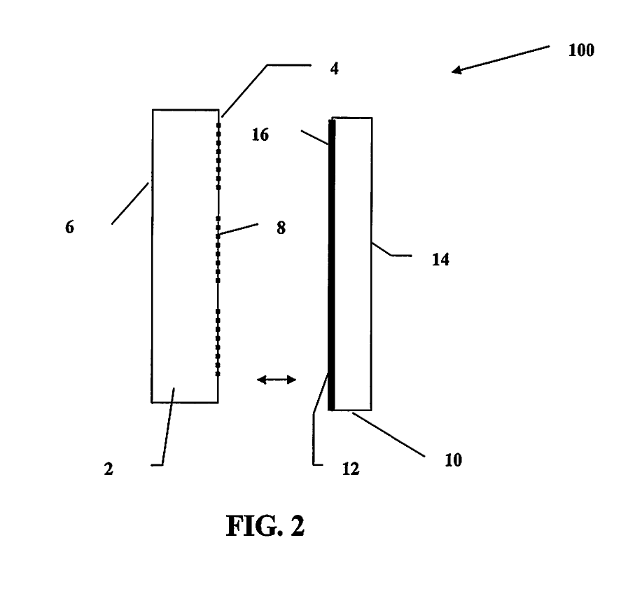

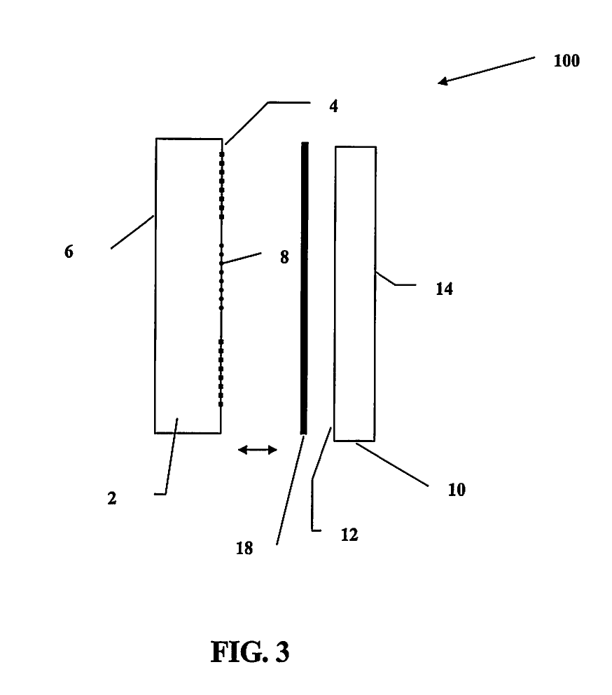

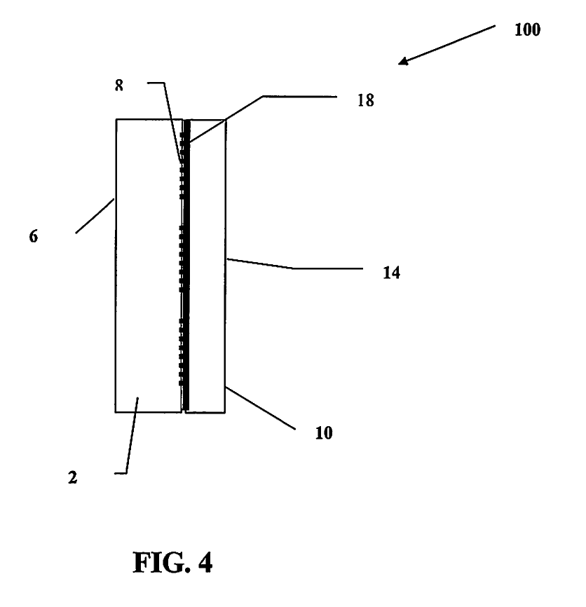

The first side 12 of the second polymeric liner sheet 10 is attached to the first side 4 of the first polymeric liner sheet 2 such that the colored indicia 8 is positioned between the first side 4 of the first polymeric liner sheet 2 and the first side 12 of the second polymeric liner sheet 10. The attachment is done by pressing the sheets together in the direction of the arrows as shown. FIG. 2 shows one embodiment of the invention wherein the first side 12 of the transparent second polymeric liner sheet 10 is provided with surface embossing 16. The two sheets may then be attached together by sufficient heat and pressure. The action of such heat and pressure may cause the minute surface raised and depressed embossings to flatten during the attaching step. FIG. 3 shows another embodiment of the invention wherein the first side 12 of the second polymeric liner sheet 10 is attached to the first side 4 of the first polymeric liner sheet 2 via an intermediate adhesive 18. FIG. 4 is a representation of pool liner construction 100 showing first polymeric liner sheet 2 adhered to second polymeric liner sheet 10 via adhesive 18 embedding colored indicia 8. In another embodiment of the invention second side 14 of second polymeric liner sheet 10 may be provided with embossing as a slip-resisting surface.

As a first step in producing the pool liner of the invention, a first polymeric liner sheet 2 and a substantially light transparent second polymeric liner sheet 10 are produced. Preferably the first polymeric liner sheet and the second polymeric liner sheet independently comprise at least one vinyl containing polymer such as a polyvinyl chloride containing polymer. Any vinyl chloride polymers prepared by emulsion polymerization, suspension polymerization or bulk polymerization may be used in the present invention. The vinyl chloride resin may be a homopolymer of vinyl chloride or a mixed polymer, such as copolymers or graft polymers of vinyl chloride which have been prepared by known continuous or batch polymerization processes. Suitable monomers for copolymerization with vinyl chloride are olefins, vinyl esters of carboxylic acids, acrylonitrile, styrene and cyclohexylmaleimide. Polymers useful for graft polymerization with vinyl chloride include elastomeric polymers of butadiene, ethylene, propylene, styrene and/or acrylonitrile. Illustratively, the PVC resin may have a molecular weight of from about 115,000 to about 225,000. Additionally, such compositions may further include additives known in the art, such as plasticizers, heat stabilizers, ultraviolet (UV) absorbers, antioxidants, co-stabilizers, lubricants, pigments, biocides, processing aids, and fillers.

Conventional plasticizers for PVC can be used in this invention. Illustrative of such plasticizers are phthalic acid esters such as dibutyl phthalate, dioctyl phthalate, diisodecyl phthalate, diisoundecyl phthalate, etc.; trimellitic acid esters such as trioctyl trimellitate, tri-2-ethylhexyl trimellitate, tridecyl trimellitate, etc.; adipic acid esters such as dioctyl adipate, diisodecyl adipate, di-2-ethylhexyl adipate, etc.; phosphoric acid esters such as tricresyl phosphate, trioctyl phosphate, etc; epoxy plasticizers and liquid polyesters. The preferred plasticizers are those of the phthalic acid esters and adipic acid esters, particularly those wherein each of the hydrocarbyl substituents on the phthalate or adipate are straight chain alkyl groups having at least 7 carbon atoms such as that of 7 to 11 carbon atoms. The straight chain phthalates and adipates have greater permanence in the composition and keep the film flexible for a longer period of time. The straight chain alkyl groups of 7 or more carbon atoms can be the same or different on each of the phthalate or adipate groups. Also, the alkyl groups can have an odd number or an even number of carbon atoms. Illustrative of such straight chain groups there can be mentioned those of n-heptyl, n-octyl, n-nonyl, n-decyl, and n-undecyl, e.g., such as with n-nonyl, n-nonyl phthalate. Preferably the first and second polymeric liner sheets comprise a plasticizer in an amount of from about 20 weight percent to about 55 weight percent based on the weight of the respective first or second polymeric liner sheet.

Conventional heat stabilizers which can be employed in the compositions of this invention non-exclusively include salts of a carboxylic acid with a metal such as barium, tin, calcium, magnesium, zinc or the like either individually or in combination. Also, the stabilizer can be an organic ester of phosphorous acid or the like and combinations of such ester with a carboxylic acid salt. The organic ester of phosphorous acid, which may be used as the heat stabilizer is typically an aryl or alkyl phosphite such as a mono-, di-, or trialkyl phosphite. The number of carbon atoms in each alkyl group can vary over a wide range such as from 4 to 24 carbon atoms. The organic ester of phosphorous acid can also be a polyol ester type phosphite. Illustrative of alkyl phosphites there can be mentioned: triisooctyl phosphite, triisodecyl phosphite, distearylpentaerythritol diphosphite, tributyl phosphite, zinc and/or barium mono- or dialkyl phosphites such as dihexyl zinc di(dihexyl phosphite), zinc di(dilauryl phosphite), barium di (dioctyl phosphite), zinc di(dinonyl phosphite), barium di(dipalmityl phosphite) and the like. Further examples of heat stabilizers include metal soap heat stabilizers such as Ca, Mg and Ba salts of fatty acids, e,g., 2-hexylhexanoic acid, lauric acid, myristic acid, palmitic acid, stearic acid, hydroxystearic acid, linoleic acid, behenic acid, isostearic acid, oleic acid and ricinoleic acid, composite metal salt heat stabilizers such as Ca/Zn and Ba/Zn salts of fatty acids; phosphite type heat stabilizers such as various trialkyl phosphites, e.g., trioctyl phosphite, oligophosphites , e,g., pentaerythritol phosphite, and the like. The heat stabilizer can be a mixture of a barium and a zinc salt of a carboxylic acid, or of a phosphite. barium-zinc-alkyl phosphite heat stabilizer. One useful heat stabilizer is a mixed-barium-zinc-alkyl phosphite composition. The barium and zinc stabilizers provide good chemical resistance, e.g., from swimming pool chemicals as well as acidic and alkaline pool liner cleaners. The alkyl phosphite improves stain resistance and provides improved results in comparison with aromatic phosphites. Preferably the first and second polymeric liner sheets comprise a heat stabilizer in an amount of from about 2 weight percent to about 3 weight percent based on the weight of the respective first or second polymeric liner sheet.

Conventional ultraviolet light absorbers that can be used include a benzotriazole compound, benzophenone compound, or a hindered amine compound and specifically includes 2-(3,5-di-t-butyl-2-hydroxyphenyl)benzotriazole; 2 -(3,5-di-t-butyl-2-hydroxyphenyl)-5-benzotriazole; polycondensate of dimethyl succinate with 1-(2-hydroxyethyl)-4-hydroxy-2,2,6,6-tetramethylpiperidine, various 2-hydroxy-4-alkoxybenzophenones, e.g., 5,5′-methylenebis(2hydroxy-4-lauroxybenzophenone), 5,5′-methylenebis(2-hydroxy-4-octoxybenzophenone), and the like. One useful UV absorber is a 2-hydroxy-4-(2-hydroxyloweralkoxy)benzophenone having from 1 to 4 carbon atoms in the alkoxy group. Preferably the first and second polymeric liner sheets comprise an ultraviolet light absorber in an amount of from about 0.2 weight percent to about 2.0 weight percent based on the weight of the respective first or second polymeric liner sheet.

Useful anti-oxidant include a sterically hindered phenol such as Irganox 1010, and 2,6-di-tert.-butyl-p-cresol. Other useful anti-oxidants non-exclusively include Irganox 1076. Preferably the first and second polymeric liner sheets comprise an anti-oxidant in an amount of from about 0.2 weight percent to about 2.0 weight percent based on the weight of the respective first or second polymeric liner sheet. A useful co-stabilizer is dilaurylthiodipropionate.

Lubricants for polyvinyl chloride can also be added. A useful lubricant is a fatty acid lubricant such as stearic acid. Other useful lubricant non-exclusively include calcium stearate, and zinc laurate. Preferably the first and second polymeric liner sheets comprise a lubricant in an amount of from about 0.2 weight percent to about 1.0 weight percent based on the weight of the respective first or second polymeric liner sheet.

Useful pigments include a conductive powder such as a metal powder of iron, silver, copper aluminum, titanium or their alloys, a metal oxide powder, a metal carbide powder, a metal boride powder, carbon black, graphite or combinations thereof. Preferably the first and second polymeric liner sheets comprise a pigment in an amount of from about 2.0 weight percent to about 15.0 weight percent based on the weight of the respective first or second polymeric liner sheet. The quantity of pigment, when used, will be sufficient to provide the proper amount of coloration to a liner sheet.

Useful biocide may be an organic arsenic compound such as 10,10′-oxybisphenoxarsine. Other useful biocides non-exclusively include 2-n-octyl-4-isothiazolin-3-one (OIT), 4,5-dichloro-2-n-octyl-4-isothiazoline-3-one (DCOIT), barium metaborate, zinc pyrathine. Preferably the first and second polymeric liner sheets comprise a biocide in an amount of from about 0.1 weight percent to about 1.0 weight percent based on the weight of the respective first or second polymeric liner sheet. The compositions can also include processing aids such as acrylic processing aids. Preferably the first and second polymeric liner sheets comprise a processing aids in an amount of from about 0.5 weight percent to about 2.0 weight percent based on the weight of the respective first or second polymeric liner sheet.

The process of combining and mixing ingredients generally includes the following steps. The polymer is pumped from a silo into a large ribbon blender. The polymer is heated to about 160° F. when a plasticizer is introduced after being weighted to coincide with the correct “hand” of the film, i.e., the tactile qualities such as softness, firmness, elasticity, fineness, resilience and other qualities perceived by touch. Pigment, process aids, stabilizers and other optional ingredients are added to form the blend that provides the raw material for the film. The blend is then released to a series of surge hoppers and scales to control the amount introduced into a Banbury mixer. A typical batch weights from about 140 to about 180 pounds. The Banbury mixer is an intensive mixer that converts the powder released from the blenders into a putty like form. This putty drop releases from the Banbury mixer to a series of belts and is placed on a mill. The mill is a piece of equipment with two roller turning inward. The mill is heated with steam or some other heat source and keeps the batches hot as they await movement into the extruder. The mill allows the changeover from a batch process to a continuous process as the material is fed into an extruder, thus creating a bead that travels up a belt, through a metal detector and between the two rolls of the calender. The material is processed between the calender rolls to form a sheet generally from about 2.5 mils to about 50 mils in thickness. After the film is formed it is pulled off the roller by pickers, travels thought a section of cooling cans and is wound into rolls which thus forms the first or second polymeric sheet.

An important feature of the invention is that each of the first polymeric liner sheet and the second polymeric liner sheet define a longitudinal direction, and a transverse direction orthogonal to the longitudinal direction. During the formation of the polymeric liner sheets through the calender rollers as described above, the forward direction of travel of the polymeric liner sheet is the longitudinal direction and the transverse direction is 90° and in the plane of the longitudinal direction. If less than 4 mils in thickness, the first or second polymeric liner sheet thickness will usually have a tensile strength of from about 2,300 psi to about 2,900 psi in the longitudinal direction. A first or second polymeric liner sheet of less than 4 mils in thickness usually has a transverse direction tensile strength of from about 2,300 psi to about 2,900 psi. A first or second polymeric liner sheet of less than 4 mils in thickness usually has an elongation percentage in the longitudinal direction of from about 160 percent to about 325 percent. A first or second polymeric liner sheet of less than 4 mils in thickness usually has an elongation percentage in the transverse direction of from about 200 percent to about 325 percent. The first and second polymeric liner sheet will also have certain secant modulus properties. A first or second polymeric liner sheet of less than 4 mils in thickness usually has a secant modulus in the longitudinal direction of from about 1,700 psi to about 2,100. A first or second polymeric liner sheet of less than 4 mils in thickness usually has a secant modulus in the transverse direction of from about 1,000 psi to about 1,500 psi.

A first or second polymeric liner sheet of from about 4 mils to about and 8 mils in thickness will have a tensile strength of from about 2,200 psi to about 2,700 psi in the longitudinal direction. A first or second polymeric liner sheet of from about 4 mils to about and 8 mils in thickness will have a transverse direction tensile strength of from about 1,700 psi to about 2,400 psi. A first or second polymeric liner sheet of from about 4 mils to about and 8 mils in thickness will have a percentage elongation in the longitudinal direction of from about 160 percent to about 325 percent. A first or second polymeric liner sheet of from about 4 mils to about and 8 mils in thickness will have an elongation in the transverse direction of from about 160 percent to about 325 percent. The first and second polymeric liner sheet will also have certain secant modulus properties. A first or second polymeric liner sheet of from about 4 mils to about and 8 mils in thickness will have a secant modulus in the longitudinal direction of from about 1,300 psi to about 2,100. A first or second polymeric liner sheet of from about 4 mils to about and 8 mils in thickness will have a secant modulus in the transverse direction of from about 1,000 psi to about 2,100 psi.

The first or second polymeric liner sheet of over 8 mils in thickness will generally have a tensile strength of from about 2,000 psi to about 2,600 psi in the longitudinal direction. A first or second polymeric liner sheet of over 8 mils will generally have a transverse direction tensile strength of from about 2,000 psi to about 2,600 psi. A first or second polymeric liner sheet of over 8 mils will generally have percentage elongation in the longitudinal direction of from about 220 percent to about 325 percent. A first or second polymeric liner sheet of over 8 mils will generally have elongation in the transverse direction of from about 220 percent to about 360 percent. A first or second polymeric liner sheet of over 8 mils will generally have a secant modulus in the longitudinal direction of from about 1,000 psi to about 2,000 psi A first or second polymeric liner sheet of over 8 mils will generally have a secant modulus in the transverse direction of from about 1,000 psi to about 2,100 psi.

Each of the first polymeric liner sheet and the second polymeric liner sheet have a minimum longitudinal direction elongation at break of about 160%. In a preferred embodiment, the longitudinal direction elongation at break ranges from about 200% to about 300%, and more preferably from about 240% to about 260%. Each sheet has a minimum transverse direction elongation at break of about 160%. In a preferred embodiment, the transverse direction elongation at break ranges from about 200% to about 300%, and more preferably from about 240% to about 260%.

Each sheet has a maximum tensile strength in the longitudinal direction of about 3000 pounds per square inch. In a preferred embodiment, the tensile strength in the longitudinal direction ranges from about 2200 to about 2800 pounds per square inch, and more preferably from about 2400 to about 2600 pounds per square inch. Each sheet has a maximum tensile strength in the transverse direction of about 3000 pounds per square inch. In a preferred embodiment, the tensile strength in the transverse direction ranges from about 2100 to about 2700 pounds per square inch, and more preferably from about 2300 to about 2500 pounds per square inch. Each sheet has a maximum secant modulus in the longitudinal direction of about 2100 pounds per square inch. In a preferred embodiment, the secant modulus in the longitudinal direction ranges from about 1300 to about 2000 pounds per square inch, and more preferably from about 1600 to about 1800 pounds per square inch. Each sheet has a maximum secant modulus in the transverse direction of about 2100 pounds per square inch. In a preferred embodiment, the secant modulus in the transverse direction ranges from about 1100 to about 1700 pounds per square inch, and more preferably from about 1300 to about 1500 pounds per square inch.

Preferably, the first polymeric liner sheet and the second polymeric liner sheet have each of a minimum longitudinal direction elongation at break which is no more than about 110% of the other; a minimum transverse direction elongation at break which is no more than about 110% of the other; a maximum tensile strength in the longitudinal direction which is no more than about 110% of the other, a maximum tensile strength in the transverse direction which is no more than about 110% of the other; a maximum secant modulus in the longitudinal direction which is no more than about 110% of the other, and a maximum secant modulus in the transverse direction which is no more than about 110% of the other.

Usually, the first polymeric liner sheet has a thickness of from about 0.008 inch to about 0.036 inch, preferably from about 0.012 inch to about 0.028 inch , and more preferably from about 0.016 inch to about 0.024 inch. Usually, the second polymeric liner sheet has a thickness of from about 0.0027 inch to about 0.020 inch, preferably from about 0.0035 inch to about 0.012 inch , and more preferably from about 0.0045 inch to about 0.010 inch.

After the first polymeric sheet is formed, it is provided with a colored indicia on at least a portion of its first side. Any suitable colorant composition may be employed as the colored indicia, however, pigment compositions are preferred over dye composition since pigments are essentially insoluble in a chemical environment for pool liners. Pigments also have a greater fading resistance. Suitable colorant compositions include carbon black, phthalocyanine blue, indoline blue, red-violet, chromo red brown, green shade yellow, TiO₂ white and clear extender. Such may be applied and dried onto the first side of the first polymeric sheet by any suitable means such as gravure printing, intaglio printing, lithographic printing, or the like, as are well known in the art.

After each of the first polymeric liner sheet and the second polymeric liner sheet are formed, they are attached to one another such that the first side of the second polymeric liner sheet is attached to the first side of the first polymeric liner sheet such that the colored indicia is positioned between them. Substantially the entirety of the first side of the second polymeric liner sheet is attached to the first side of the first polymeric liner sheet. Attaching can be done by any method known in the art. In one embodiment, the first side of the second polymeric liner sheet is provided with embossing throughout its entire side as shown in FIG. 2. The embossed first side of the second polymeric liner sheet is attached to the first side of the first polymeric liner sheet by means of sufficient heat and pressure. Useful heating temperatures may range from about 300° F. to about 380° F. Useful pressures may range from about 1,000 psi to about 1,500 psi. Heating may be done by a hot wire, hot rods, heat drums an oven or the like. Pressure may be done by leading the sheets through the nip of pressure rollers. Well known embossing techniques impart a design of minute hills and valleys within the surface of the first side of the second polymeric liner sheet. Such may be wholly or partially flattened by the action of the heat and pressure used for attaching. In another embodiment, the first side of the second polymeric liner sheet is attached to the first side of the first polymeric liner sheet are attached by a suitable adhesive such as Plastisol which is a suspension of PVC particles in a plasticizer. Plastisol flows as a liquid when heated and the PVC and plasticizer mutually dissolve each other. On cooling, a flexible, permanently plasticized product results. A representation of a resulting pool liner with first and second polymeric liner sheets attached via an adhesive embedding colored indicia is shown in FIG. 4. In order to impart a textured surface to improve feel and comfort to a second side of the second polymeric liner sheet, such may optionally be provided with an embossed surface. Optionally, the first side of the second polymeric liner sheet further comprises a colored indicia which is formed and applied in a similar manner similar.

In use, a pool assembly is formed by comprising a substantially concave pool of excavated earth which is supported by a suitable framework defining inside walls. The pool liner construction is suitably cut, seamed, tailored and positioned on substantially the entirety of the inside walls. The liner is held in place against the inside walls by the pressure of pool liquid, usually water or salt water.

The following non-limiting example serves to illustrate the invention.

### EXAMPLE

The following components are combined: 100 parts by weight of polyvinyl chloride polymer having an average molecular weight in the range of from about 115,000 to about 225,000, 49 parts plasticizer, 3 parts biocide, 1 part processing aid, 3.38 parts stabilizer, and 2 parts UV inhibitor, for a total of 158.38 parts.

The polymer is pumped from a silo into a large ribbon blender. The polymer is heated to about 160 ° F. when the other components are introduced. The blend is then released to a series of surge hoppers and scales to control the amount introduced into a Banbury mixer. The batch weights from about 140 to about 180 pounds. The Banbury mixer converts the blend into a putty like form. This putty is released from the Banbury mixer to a series of belts and is then placed on a mill. The mill is heated and keeps the batch hot as it awaits movement into an extruder and then between the two rolls of a calender. The material is processed between the calender rolls to form a sheet. After the film is formed it is pulled off the rollers by pickers, travels thought a section of cooling cans and is wound into rolls which thus forms the first or second polymeric sheet at the desired thickness. A first produced polymeric liner sheet has a thickness of from about 0.008 inch to about 0.036 inch, and a second produced polymeric liner sheet has a thickness of from about 0.0027 inch to about 0.020 inch. Samples of each of the first polymeric liner sheet and the second polymeric liner sheet are then attached to one another.

A first side of a sample of the second polymeric liner sheet is provided with embossing throughout its entire side. The embossed first side of the second polymeric liner sheet is attached to the first side of the first polymeric liner sheet by heating by a hot wire at temperatures may from about 300° F. to about 380° F. while simultaneously applying a pressure of range from about 1,000 psi to about 1,500 psi by leading the sheets through the nip of pressure rollers to form a pool liner.

A quantity of a Plastisol, a suspension of PVC particles in a plasticizer is heated and liquefied. It is applied between another sample of the second polymeric liner sheet and another sample of a first polymeric liner sheet. The three layer arrangement is pressed together applying a pressure of range from about 1,000 psi to about 1,500 psi by leading the sheets through the nip of pressure rollers and then cooled to room temperature to form a pool liner. The pool liner is cut, seamed and tailored to the configuration of an in-ground swimming pool. The tailored liner is positioned within a concave structural shell placed in a hole excavated in the ground which is then filled with water.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A pool liner comprising a first polymeric liner sheet having a first side and a second side; a substantially light transparent second polymeric liner sheet having a first side and a second side; a colored indicia on at least a portion of the first side of the first polymeric liner sheet and/or a colored indicia on at least a portion of the first side of the substantially transparent second polymeric liner sheet; the first side of the second polymeric liner sheet being attached to the first side of the first polymeric liner sheet such that the colored indicia is positioned between the first side of the first polymeric liner sheet and the first side of the second polymeric liner sheet, each of the first polymeric liner sheet and the second polymeric liner sheet defining a longitudinal direction, and a transverse direction orthogonal to the longitudinal direction, each of the first polymeric liner sheet and the second polymeric liner sheet having a minimum longitudinal direction elongation at break of about 160%, a minimum transverse direction elongation at break of about 160%, a maximum tensile strength in the longitudinal direction of about 3000 pounds per square inch, a maximum tensile strength in the transverse direction of about 3000 pounds per square inch, a maximum secant modulus in the longitudinal direction of about 2100 pounds per square inch, and a maximum secant modulus in the transverse direction of about 2100 pounds per square inch.

2. The pool liner of claim 1 wherein the first polymeric liner sheet has a thickness of from about 0.008 inch to about 0.036 inch, and the second polymeric liner sheet has a thickness of from about 0.0027 inch to about 0.020 inch.

3. The pool liner of claim 1 wherein the first polymeric liner sheet and the second polymeric liner sheet have each of a minimum longitudinal direction elongation at break which is no more than about 110%; a minimum transverse direction elongation at break which is no more than about 110% of the other; a maximum tensile strength in the longitudinal direction which is no more than about 110% of the other, a maximum tensile strength in the transverse direction which is no more than about 110% of the other; a maximum secant modulus in the longitudinal direction which is no more than about 110% of the other, and a maximum secant modulus in the transverse direction which is no more than about 110% of the other.

4. The pool liner of claim 1 wherein the first polymeric liner sheet and the second polymeric liner sheet independently comprise at least one vinyl polymer.

5. The pool liner of claim 1 wherein the a first polymeric liner sheet and the second polymeric liner sheet independently comprise a polyvinyl chloride polymer.

6. The pool liner of claim 1 wherein the a first polymeric liner sheet and the second polymeric liner sheet are attached by an intermediate adhesive.

7. The pool liner of claim 1 wherein the intermediate adhesive comprises a suspension of polyvinyl chloride polymer particles and a plasticizer.

8. The pool liner of claim 1 wherein the a first polymeric liner sheet and the second polymeric liner sheet are attached by heat sealing.

9. The pool liner of claim 1 wherein the first side of the second polymeric liner sheet has an embossed surface.

10. The pool liner of claim 1 wherein the second side of the second polymeric liner sheet has an embossed surface.

11. The pool liner of claim 1 wherein the first polymeric liner sheet comprises a plasticizer in an amount of from about 20 weight percent to about 55 weight percent based on the weight of the first polymeric liner sheet, and the second polymeric liner sheet comprises a plasticizer in an amount of from about 20 weight percent to about 55 weight percent based on the weight of the second polymeric liner sheet.

12. The pool liner of claim 1 wherein the first side of the second polymeric liner sheet further comprises a colored indicia.

13. A pool assembly comprising a substantially concave pool defining inside walls, and the pool liner of claim 1 positioned on substantially the entirety of the inside walls.

14. A process for producing a pool liner which comprises:
a) providing a first polymeric liner sheet having a first side and a second side;
b) providing a substantially light transparent second polymeric liner sheet having a first side and a second side;
a colored indicia on at least a portion of the first side of the first polymeric liner sheet and/or a colored indicia on at least a portion of the first side of the substantially transparent second polymeric liner sheet;
wherein each of the first polymeric liner sheet and the second polymeric liner sheet define a longitudinal direction, and a transverse direction orthogonal to the longitudinal direction, each of the first polymeric liner sheet and the second polymeric liner sheet having a minimum longitudinal direction elongation at break of about 160%, a minimum transverse direction elongation at break of about 160%, a maximum tensile strength in the longitudinal direction of about 3000 pounds per square inch, a maximum tensile strength in the transverse direction of about 3000 pounds per square inch, a maximum secant modulus in the longitudinal direction of about 2100 pounds per square inch, and a maximum secant modulus in the transverse direction of about 2100 pounds per square inch;
c) attaching the first side of the second polymeric liner sheet to the first side of the first polymeric liner sheet such that the colored indicia is positioned between the first side of the first polymeric liner sheet and the first side of the second polymeric liner sheet.

15. The process of claim 14 wherein substantially the entirety of the first side of the second polymeric liner sheet in step b) has an embossed surface.

16. The process of claim 14 wherein the attaching is conducted by heat sealing the first side of the second polymeric liner sheet to the first side of the first polymeric liner sheet.

17. The process of claim 14 wherein the attaching is conducted by adhering the first side of the second polymeric liner sheet to the first side of the first polymeric liner sheet with an intermediate adhesive.

18. The process of claim 14 further comprising a subsequent step d) of forming an embossed surface on a second side of the second polymeric liner sheet.

19. The process of claim 14 wherein the a first polymeric liner sheet and the second polymeric liner sheet independently comprise at least one vinyl polymer.

20. The process of claim 14 wherein the a first polymeric liner sheet and the second polymeric liner sheet independently comprise a polyvinyl chloride polymer.
